(19) United States
(12) Patent Application Publication
(10) Pub. No.: US 2013/0284764 A1
(43) Pub. Date: Oct. 31, 2013

(54) DISPENSER WITH RE-SEALABLE FLOOR

(71) Applicant: CHERYL EVON BAXTER-WALLER, Houston, TX (US)

(72) Inventor: CHERYL EVON BAXTER-WALLER, Houston, TX (US)

(21) Appl. No.: 13/455,457

(22) Filed: Apr. 25, 2012

(51) Int. Cl. G01F 11/00; B05C 17/01

(52) U.S. Cl. 222/321.9; 222/482

(57) ABSTRACT

A dispenser provides improved access to the interior contents of a container. A re-sealable floor may be hinged or threaded allowing repeated opening and closing of the floor to access, for example, contents that remain within the container that are otherwise not dispensed from an opening opposite the floor.

### BACKGROUND OF THE INVENTION

The present invention generally relates to containers, and more particularly, to dispensers with a re-sealable floor.

Many products such as creams, moisturizers, lotions, or other similar mediums tend to stick to their container surfaces, making it difficult for a user to retrieve and use all the container's contents. For example, dispensers may use pumps to retrieve a container's contents. The stem of the pump may not extend to the floor of the container thus, leaving a substantial layer of product remaining on the dispenser floor. Additionally, for viscous products, a layer of the product may adhere to inner side walls of the container.

In some cases, the use of one's finger's to reach the interior of the container is inadequate to retrieve the remaining contents. Typically, some users may attempt to forcefully shake remaining product out a dispenser's conventional open dispensing end. Other users may resort to cutting the container to gain access to the remaining product in the container.

As can be seen, there is a need for dispenser that allows access to manual access to its interior for retrieval of contents.

### SUMMARY OF THE INVENTION

In one aspect of the present invention, dispenser comprises a container including a side wall; an opening on a first end of the container adapted to dispense a fluid from the opening; a male threaded boss on a second end of the container; and a re-sealable floor including a female threaded boss configured to couple to the male threaded boss.

In another aspect of the present invention, a dispenser comprises a container including a side wall; a first end of the container adapted to dispense a fluid from an opening in the container; a hinge on the side wall, the hinge being positioned at a second end opposite the first end; and a floor coupled to the hinge, wherein an edge of the floor is adapted pivot from the hinge, and the floor is adapted to seal and reseal the second end.

These and other features, aspects and advantages of the present invention will become better understood with reference to the following drawings, description and claims.

### BRIEF DESCRIPTION OF THE DRAWINGS

FIG. 1 shows a side view of a dispenser according to an exemplary embodiment of the present invention as oriented during conventional use;

FIG. 2 shows a perspective bottom view of the dispenser of FIG. 1 sans pump;

FIG. 3 shows a side view of a dispenser according to another exemplary embodiment of the present invention; and

FIG. 4 shows a side view of the dispenser of FIG. 3 as oriented upside down during use for retrieval of remaining contents.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claim.

Broadly, an embodiment of the present invention generally provides a dispenser with a re-sealable floor. The dispenser may be used, for example, in dispensing viscous fluids. In an exemplary use, the dispenser 10 may be filled with cosmetic mediums of lotions, creams, or gels.

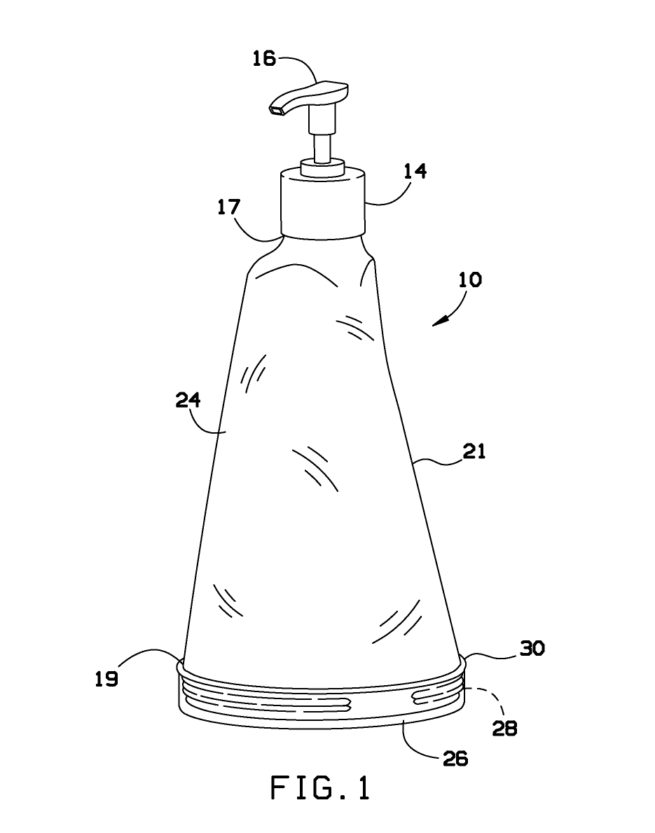

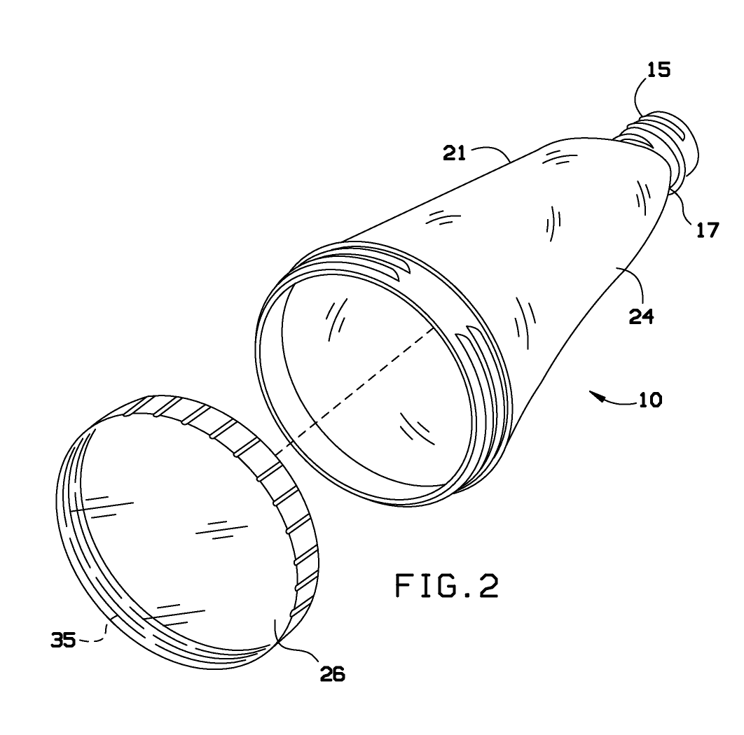

Referring to FIGS. 1 and 2, a dispenser 10 is shown in accordance with an exemplary embodiment of the present invention. The dispenser 10 may include a container 24 and a re-sealable floor 26.

The container 24 may be, for example, a bottle adapted to hold cosmetic mediums within. The container 24 may include a dispensing end 17, a bottom end 19, and one or more side walls 21. The side wall may 21, in some exemplary embodiments, be rigid. In some exemplary embodiments, the side wall 21 may be resilient so that manual squeezing of the container 24 may force contents out the dispensing end 17 while allowing the side wall 21 to return to its original form.

The dispensing end 17 may include an opening (not shown) for allowing fluid contents (not shown) to pass there through. The dispensing end 17 may include in some exemplary embodiments, a pump 16 (FIG. 1). The pump 16 may be coupled to a cap 14 attached to the container 24. A stem (not shown) of the pump 16 may extend through the opening (not shown) into the container 24 interior. The cap 14 may be threaded onto a threaded boss 15 or press fit onto the dispensing end 17. The attachment means for the cap 14 is omitted from view for sake of illustration. Similarly, the opening on the dispensing end 17 and features of the pump 16 within the dispenser 10 are omitted from view for sake of illustration.

In one aspect, the floor 26 may be configured to provide repeated access to the container 24 interior and re-use of the dispenser 10 for dispensing of fluids. The re-sealable floor 26 may be attached to the bottom end 19. The container 24 may include a male threaded boss 28 (as seen in the cutaway portion of the floor 26 in FIG. 1) that may be screwed onto a female threaded boss 35 (as seen from the underside of the floor 26 in FIG. 2) allowing repeated access to the container 24 interior. The floor 26 may include a lip 30 that is positioned above the male threaded boss 26 when the floor 26 is screwed into place. The lip 30 may provide a seal against fluid contents escaping the container 10.

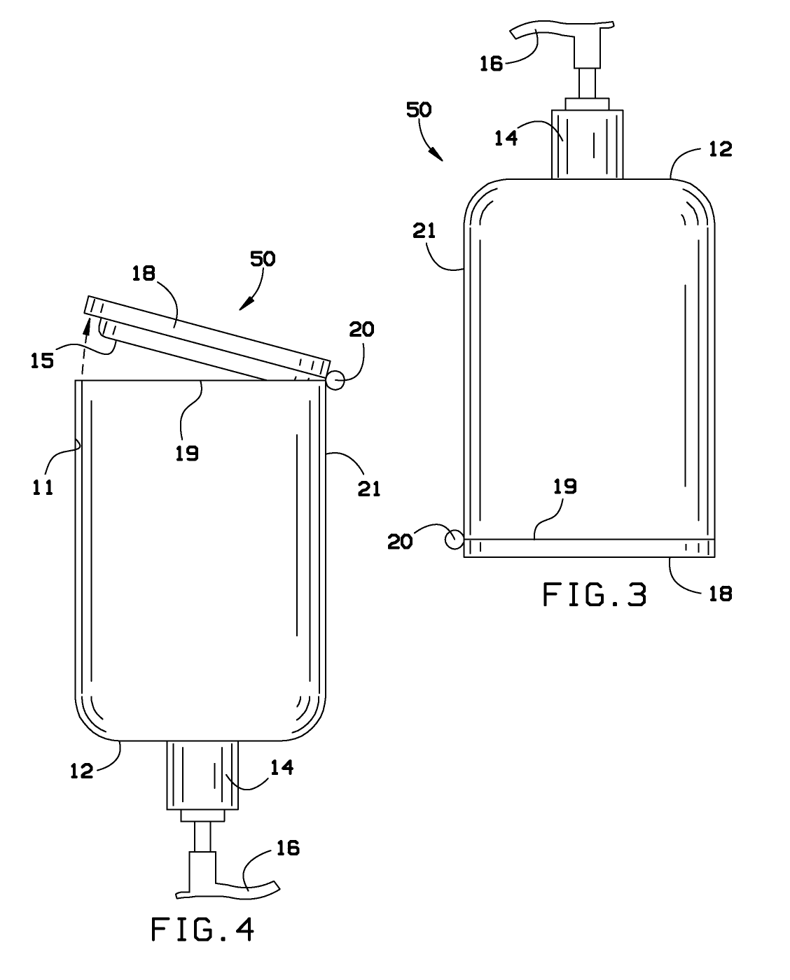

Referring now to FIGS. 3 and 4, a dispenser 50 is shown in accordance with another exemplary embodiment of the present invention. Dispenser 50 is similar to dispenser 10 except that dispenser 50 includes a container 12 with a floor 18 attached to the side wall 21 by a hinge 20 proximate the bottom end 19. An edge of the floor 18 may be attached to the hinge 20 so that the floor 18 pivots partially about the hinge 20 allowing access to the container 50 interior through the bottom end 19. The floor 18 may include a gasket 15. The gasket 15 may be positioned to provide a press-fit seal against an interior wall 11 of the container 50.

It should be understood, of course, that the foregoing relates to exemplary embodiments of the invention and that modifications may be made without departing from the spirit and scope of the invention as set forth in the following claim.

1. A dispenser, comprising:
a container including a side wall;
an opening on a first end of the container adapted to dispense a fluid from the opening;
a male threaded boss on a second end of the container, wherein the second end of the container is substantially near a bottom end of the container; and
a re-sealable floor including a female threaded boss along the re-sealable floor configured to couple to the male threaded boss, wherein the re-sealable floor is the lowest surface of the container.

2. The dispenser of claim 1 further comprising a pump coupled to the opening on the first end, the pump adapted to withdraw contents from within the container during use.

3. (canceled)

4. (canceled)

5. (canceled)

6. The dispenser of claim 1 further comprising a lip above the male threaded boss.

7. The dispenser of claim 1, wherein the side wall extends between the first end of the container and the second end of the container.

8. The dispenser of claim 1 further comprising a cap coupled to the opening on the first end.
